(19) United States
(12) Patent Application Publication
(10) Pub. No.: US 2026/0055808 A1
(43) Pub. Date: Feb. 26, 2026

(54) INDUSTRIAL GEAR UNIT IN THE FORM OF A PLANETARY TRANSMISSION WITH AN INTERMEDIATE ELEMENT ASSEMBLY AND METHOD AND USE

(71) Applicant: Flender GmbH, 46395 Bocholt (DE)

(72) Inventors: THORSTEN FINGERLE, Bocholt (DE); CHRISTOPH LOHMANN, Bocholt (DE); VOLKER LENSING, Bocholt (DE); RALF KLEINE-BROCKHOFF, Bocholt (DE)

(73) Assignee: Flender GmbH, 46395 Bocholt (DE)

(21) Appl. No.: 19/104,966

(22) PCT Filed: Sep. 19, 2023
(86) PCT No.: PCT/EP2023/075768

§ 371 Date: Feb. 19, 2025

(30) Foreign Application Priority Data
Sep. 19, 2022 (EP) 22196298.8

(51) Int. Cl. F16H 57/08; F03D 15/10; F16C 33/12; F16H 1/28

(52) U.S. Cl. CPC F16H 57/082; F16C 33/122; F16H 1/28; F03D 15/101; F05B 2260/40311; F16H 2057/085

(57) ABSTRACT

An industrial gear unit designed as a planetary transmission for installation in a wind power installation includes an axle receptacle, an axle including two axial portions via which the axle is mounted in the axle receptacle in an axially fixed manner on both sides of a planet gear of the planetary transmission, and an intermediate element assembly mounted in an axially fixed manner between the axle and the axle receptacle in at least one of the axial portions of the axle and acting between the axle receptacle and the axle. The intermediate element assembly includes a surface portion which faces the axle and/or the axle receptacle and has a structured surface with a laser-structured surface for restraining the intermediate element assembly against displacement in an axial direction.

### TECHNICAL FIELD

The present invention relates to an industrial gear unit in the form of a planetary transmission, having at least one axle and at least one axle receptacle for mounting the axle in an axially fixed manner, wherein the axle is mounted in an axially fixed manner in at least one axial portion in the axle receptacle, selectively is mounted in two axial portions in particular in each case on a free end of the axle, wherein an intermediate element assembly is provided between the axle receptacle and the axle in a manner acting in the/in the at least one axial portion, in particular having the industrial gear unit in the form of a planetary transmission, or comprising at least one planetary transmission stage. Furthermore, the present invention also relates to intermediate elements having advantageously structured surfaces for such an intermediate element assembly. The present invention relates in particular to an industrial gear unit according to features of the independent device claim, and to methods and uses according to the coordinate claims.

### Background of the Invention

High output densities in (industrial) gear units such as, for example, planetary transmissions, in particular of wind power installations (wind power installation power trains), require sufficient stiffnesses, in particular also of the torque-conducting components, and corresponding fastenings and fixings. Especially in planetary transmissions, axle fixings on planet carriers with multiple planets tend to perform disadvantageous micro-movements under load in particular when sufficient compression is undershot, this potentially causing noticeably increased wear. It has now been recognized that such local micro-movements (and thus associated wear) become increasingly more probable as a function of an output density-induced loss of stiffness in surrounding components. There is therefore a high level of interest in being able to ideally completely suppress these micro-movements.

To date, axle fixings in this regard are implemented by extending the fixing length (in particular in the case of disadvantageous installation space requirements) and/or by increasing the fit and thus increasing compression in the contact region between the axle and the axle receptacle (in particular the bore). However, the regions about the axle fixings can be elastically deformed as a function of the load, in particular also in a planet carrier. In particular in the case of thin-walled components, this has a potentially very negative effect in particular on adjacent bearing seats. For example, a too soft planet carrier leads to the effect that very high axial forces act in the region of the planetary pins. In the process, a self-reinforcing negative effect resulting from a press fit which is increasingly becoming loose, or enlarged, is also disadvantageous, which as a consequence leads to even greater displacements or relative movements in the contact region, as a result of which even more material or abrasion is in turn generated by frictional wear. Particles released due to wear potentially lead to severe or even greater secondary damage, for example due to abrasion, as a result of which the service life of the entire gear unit is potentially very greatly reduced. The present situation makes it difficult for the person skilled in the art, in particular also in the field of planetary transmissions, to refine the latter, for example with a view to scaling the number of planets.

Accordingly, there is a high level of interest in an ideally torsionally stiff construction with a high torque bearing capability in combination with avoiding, or at least minimizing, wear in particular in the context of the particularities of planetary transmissions described here, in particular at comparatively high dynamic loads such as, for example, in power trains of wind power installations.

Publication DE 10 2011 087 568 A1 describes a pin mounting which has a shoulder and is provided for a planet gear of a spur gear differential, in which bearing sleeves are provided on both ends on a bearing pin, wherein the planet gear is rotatably mounted on the bearing pin, wherein the bearing pin can be selectively mounted so as to co-rotate or be rotatable relative to the planet gear, wherein the bearing sleeves have axial detents which extend in both radial directions, specifically outwards at one end, and inwards at the other end, so that a form fit can be ensured at a plurality of axial positions along the axial extent of the bearing pin, specifically by an axial delimitation on both sides by the planet carrier in the fashion of axial bordering by means of bearing sleeves which are S-shaped in the cross section.

### SUMMARY OF THE INVENTION

It is the object of the present invention to demonstrate measures by means of which a noticeable reduction in wear, or an effective avoidance of wear, can be ensured at an interface between the axle and the axle receptacle in planetary transmissions, in particular with a very positive (torsional) stiffness, or torque bearing capability, in particular while minimizing potential structural disadvantages caused thereby, relating to the entire gear unit construction. The object lies in particular also in providing an axially fixed mounting at the interface of axle/axle receptacle for a high-load-bearing transmission of torque, or for a particularly high loading pressure if required, in association with ease of use in ideally many variants in different types of planetary transmissions, in particular in combination with negligible wear, or at least noticeable reduction in wear, in particular also in planetary transmissions with a comparatively highly scaled number of planets, for example five, six, seven, eight or even nine planets.

The object is achieved by an industrial gear unit having the features of claim 1, by an intermediate element assembly produced according to the features of the corresponding coordinate method claim, and by corresponding uses according to the features of the corresponding coordinate use claim. Preferred design embodiments, which can represent an aspect of the invention in each case individually or in combination with one another, are set forth in the dependent claims and in the description hereunder. If a feature is illustrated in combination with another feature, this only serves for the simplified illustration of the invention and is not in any case intended to mean that this feature cannot also be a refinement of the invention without the other feature.

One aspect of the invention relates to a particularly wear-reducing, or wear-preventing, mounting of at least one axle in an (industrial) gear unit in the form of a planetary transmission.

Provided to this extent is an industrial gear unit comprising at least one planetary transmission stage having at least one axle and at least one axle receptacle for mounting the axle in an axially fixed manner, wherein the axle is mounted in an axially fixed manner in at least one axial portion in the axial receptacle, selectively is mounted in two axial portions, in particular in each case on one free end of the axle; wherein an intermediate element assembly is provided between the axle receptacle and the axle in a manner acting in the/in the at least one axial portion, which is mounted in an axially fixed manner between the axle and the axle receptacle (in particular in the fashion of a press fit, interference fit). This increases the mounting options and not least also enables individualization and stiffening, and an increase in service life, in a simple manner. It is accordingly proposed according to the invention to implement a wear-reducing measure by at least one additional intermediate element of the intermediate element assembly.

The intermediate element assembly here, in at least one surface portion at the axle and/or at the axle receptacle, has a structured surface comprising at least one (axially force-transmitting) laser-structured surface specified for support in relation to axial displacement. This also offers an effective preventive measure for avoiding wear in particular due to axial relative movements between the axle and the axle receptacle.

In the process, a comparatively high torque transmission capability and stiffness of the entire gear unit assembly can be enabled in association with a particularly torsion-resistant design embodiment; at the same time, an axial relative movement between the axle and the axle receptacle which potentially arises in particular at high dynamic loads can effectively be counteracted. The measures described here relating to the at least one intermediate element also facilitate here scaling up to a comparatively high number of planets, for example seven or more planets; such scaling potentially has the disadvantage that the sizing of each planet (axle) has to tend toward the weaker/smaller side, with associated decreasing structural strength-however, it has been demonstrated that the intermediate element assembly described here can readily compensate this potential disadvantage, the latter depending on the application and the specification sheet, in particular when implemented on each planet axle, in particular in that the planet axles, conjointly with the/the respective intermediate element(s), in structural terms replicate support rods.

It is to be understood that the intermediate element assembly described here acts in a reinforcing manner in the case of an intended installation situation and use, in particular in such a manner that the planet carrier remains torsionally stiff and is/remains specified for comparatively high torque transmission potential even with a high number of planets, as is required in particular for wind power installations also at highly dynamic load changes. In particular thanks to the high axial force transmission capability ensured at the interfaces between pins and planet carrier, the intermediate element assembly described here can ensure that an axial relative movement caused in particular by high rotational and flexural moments transmitted at the planet carrier, and thus also abrasion/wear is counteracted in association with a good stiffening effect not only in the region of the respective pin, but also in terms of the entire planet carrier.

It is to be understood that the intermediate element assembly described here acts in a wear-reducing or wear-preventing manner in the case of an intended installation situation and use, in particular because an axial relative movement can be practically precluded. If mention is made of an intermediate element assembly in general in the present disclosure, this is to be understood to mean accordingly an intermediate element assembly which is wear-reducing or wear-preventing during the intended use.

It is to be understood that a/the “structured surface” described with reference to the intermediate element assembly does not necessarily have to be provided exclusively by means of the (respective) intermediate element, but can also be, at least partially, provided by the axle and/or by the axle receptacle. For example, a comparatively finely structured structure which acts substantially in a force-fitting manner is provided at the axle, and a comparatively coarsely structured structure which acts in a form-fitting manner is provided on at least one intermediate element on an outer shell face.

It is to be understood that the terminology “structured surface” or “structure” according to the present disclosure can denote a plurality of surface portions, wherein in any case at least one laser-structured surface, or at least one laser-structured surface portion, is comprised for each axle/axle receptacle pairing. In other words: the invention is based on the concept of ensuring a wear-impeding/wear-reducing stiffening substantially based on small structures of minimum size, which can substantially ensure an axially force-transmitting axially fixed connection in a force-fitting manner, thus in combination with a normal force, in particular in a particularly torsionally stiff assembly of a planet carrier. Additionally, further structured surfaces (surface portions) can be provided, in particular such in which a form-fitting effect is also of great importance, in particular in terms of a face pairing in the region of the axle receptacle, or at the planet carrier. In the context of the concept of the present invention that is based on a force fit, it has also been demonstrated here that in addition to the laser structures, cold welding or cold-welding based on particularly smooth, in particular highly polished, surfaces can also advantageously be implemented, or be induced during operation or by the application, in particular in conjunction with microstructure or nanostructure adhesion, for example at a further axial position, which effect however is or will be also highly dependent on the operating or load situation specific to the respective application and therefore is described here only as an implementation which supplements the laser structure, for example in a further surface portion of the intermediate element assembly, in other words is not intended to replace said laser structure.

It is to be understood that the intermediate element assembly described here can have a multiplicity of intermediate elements, in particular at least one for each (planet) axle. The respective intermediate element herein can have an individual configuration, for example as a function of its axial position (for example can be designed differently at the input side of the gear unit than at the output side of the gear unit).

According to one exemplary embodiment, the intermediate element assembly comprises at least one intermediate element in one of the following design embodiments: slotted sleeve, formed bushing, formed bushing with internal nut, formed bushing in combination with cone, inter-axle grommet. This not least offers also a high degree of variability in terms of application-specific implementations, in particular also as a function of a respective number of planet axles. A/the laser structuring herein is preferably provided at least on one inner shell face.

According to one exemplary embodiment, the intermediate element assembly comprises at least one intermediate element which has at least one structured surface in at least one of the following geometric design embodiments, in particular on its external shell face: conical, spherical, knurled, provided with a toothing, shaped so as to be helical or wave-shaped. This not least also enables a specific design in terms of application-specific particularities, for example relating to the respective axle end, in particular also as a function of a respective number of planet axles. A/the laser structuring herein can also be provided independently of the (macroscopically) geometric design embodiment of the outer shell face of the intermediate element chosen in the individual case. In the case of a (rough) structuring of the outer shell face in combination with a fine, substantially force-fitting structure at the axle, the production complexity can moreover be minimized.

According to one exemplary embodiment, the intermediate element assembly comprises at least one intermediate element which is specified to be/have been incorporated in the manner of a dowel between the axle and the axle receptacle. This not least also increases the possibilities in terms of application and assembling. The incorporating, or assembling, can take place here e.g. by thermal measures (in particular also thermal joining) and/or by impact driving, or pulsed driving.

According to one exemplary embodiment, the at least one laser-structured surface is incorporated in a specific circumferential position, in particular in the region of a circumferential position at the axle, so as to deviate from a region of a circumferential position at the axle receptacle (for example by way of the respective circumferential region in the range from 45 to) 90°. This not least also makes it possible to set a comparatively specific way of fixing at the axle different from that at the axle receptacle, as a result of which load conditions in the contact region which are circumferentially and axially variable, can also be correspondingly taken into account for example.

According to one exemplary embodiment, the intermediate element assembly comprises a multiplicity of intermediate elements which, conjointly with the respective (planet) axle, in structural terms replicate support rods of the planet carrier. This not least offers a particularly high stiffness and torque transmission capability of the entire planet carrier module.

The intermediate element assembly has, in at least one surface portion at the axle (inside) and/or at the axle receptacle (outside), a laser-structured surface and is thus specified for support in an at least substantially force-fitting manner and selectively also form-fitting manner in relation to axial displacement (thus in relation to axial relative movements between the axle and the axle receptacle). The function of an axially fixed anchoring herein can be provided or ensured by an additional intermediate element assembly, or by at least one intermediate element of the intermediate element assembly, acting between the axle and the axle receptacle, in particular in an at least substantially force-fitting manner (in particular at the axle), on the one hand, and also in a form-fitting manner (in particular at the axle receptacle), on the other hand. This not least enables a more individual and more independent optimization of this Interface, which is comparatively heavily stressed in mechanical terms, in particular with a view to avoiding micro-movements, in particular in that, as opposed to the direct contact between the axle and the axle receptacle, at least one further individualizable contact face for an at least substantial force fit and selectively also form fit (here also referred to as a form fit and/or force fit) is provided, in particular also based on a material pairing which is selectable so as to be optimized for the specific application. Such an axle fixing having an intermediate element assembly also offers here numerous further even indirect advantages such as, for example, a greater variability/flexibility in the selection of the materials, or else a slimmer/more cost-effective production approach in terms of the axle and the axle receptacle, and not least also advantages in the context of assembly aspects. Particularly advantageous fields of application are derived, for example, for wind power generated gear units with friction mounting, for industrial gear units having one or a plurality of planetary transmission stages, for pure planetary gear units, and numerous further industrial applications.

It is to be understood that reference is made here in general terms to form fit and/or force fit in the context of the intermediate element assembly, in particular because individual ones of the intermediate elements of the intermediate element assembly can also be used so as to act in a substantially form-fitting manner. In terms of the laser-structured surface structure of at least one of the intermediate elements, a substantially force-fitting axially fixed retaining effect is implemented, which by means of the same intermediate element can optionally supplementarily also be combined with a form-fitting effect, in particular in the case of a formed bushing.

The structuring provided on the inner and/or outer shell face is advantageously already per se as a constituent part of the desired force fit/form fit at the corresponding contact shell face. A structuring of this type is expedient in particular in the context of a/the criterion of a robust and comparatively slim axially fixed mounting in terms of construction, or of a corresponding axially fixed installation (assembly method). In addition to the structuring, adhesive bonding, a conical press fit and/or the further types of connection described in detail here, which can be based e.g. on a combination of form fit/force fit or else can act in a substantially form-fitting manner, can be provided. It is to be understood that a materially integral fit (for example adhesive bonding), in the context of the present disclosure is to be possibly implemented additionally, for example in the context of a securing function, without a/the materially integral connection being intended to contribute toward an axial force transmission or any other comparatively high force flux.

Preferably, at least one comparatively rough surface structure which acts substantially in a form-fitting manner is provided, on the one hand, in which an axial relative movement can be precluded by a form fit, and preferably also at least one comparatively fine surface structure which acts substantially in a force-fitting/friction-fitting manner is provided, on the other hand, in which an axial relative movement can be precluded by a high level of static friction.

The surface structure acting in a form-fitting/force-fitting manner is advantageously provided on the inside as well as on the outside on shell faces of the respective intermediate element, such that fixing in relation to axial displacement/relative movement can be ensured selectively exclusively by means of the at least one intermediate element, for example also in the form of a sleeve. As a result, the respective intermediate element also meets a/the substantial function in conjunction with the axial anchoring of the axle within the axle receptacle, in particular without the axle and/or the axle receptacle necessarily having to be subjected to a specific surface treatment.

It has also been demonstrated here especially in planetary transmissions that the weaker and thus more wear-prone component (or a particularly weak component) is typically the axle receptacle (or a corresponding bore in the planet carrier) which due to the dimension of the axle receptacles, or of the planet carrier and its characteristic, can only be provided with protection against wear in a complex manner. The invention enables previous difficulties to be overcome also in this respect, and in the process also facilitates scaling toward a comparatively high number of planets.

An “industrial gear unit” herein is generally understood to mean a transmission device comprising at least one planetary transmission stage for industrial applications, for example in the form of a (bevel) spur gear or planetary transmission or screw extruder transmission or ship transmission or generator transmission or digger transmission or mill transmission or running gear transmission, in each case having at least one planetary transmission stage.

An “axially fixed mounting of the axle” herein is generally understood to mean a fixed axle seat which axially transmits force and in which a robust foothold in particular in relation to axial relative movements has to be ensured, in particular in combination with a high torsional stiffness.

In the following, mention is made of an intermediate element assembly, or alternatively an individual or respective intermediate element of the intermediate element assembly, wherein the corresponding disclosure applies in each case in an analogous manner. An intermediate element assembly herein can selectively also comprise a plurality of (intermediate) elements, whereas when reference is explicitly made to only one intermediate element, this can relate to a single element at a specific bearing point, or in a specific axial portion, for example in the region of an axle end (intermediate element assembly having a specific intermediate element at the corresponding bearing point), unless explicitly otherwise mentioned. An industrial gear unit can readily have a plurality of bearing points, or a plurality of axles, having in each case one or a plurality of intermediate elements, specifically in a planetary transmission having at least one planet carrier which provides an axle receptacle for a multiplicity of planet axles; to this extent, the term “intermediate element assembly” is also not limited to a specific number of (intermediate) elements. For example, the intermediate element assembly comprises at least a number of intermediate elements corresponding to the number of planet axles, or even at least double as many intermediate elements (attachment to two axial portions of the respective axle, in particular in the region of both axle ends).

In other words, the invention is also based on the concept of providing at least one intermediate element between the axle and the axle receptacle, or the planet carrier, which can ensure the wear protection of a/the axle receptacle, in particular of a (planet) carrier bore in a manner that can be individualized and is specific to the application, for example by defining a specific surface structure and/or material hardness. The at least one intermediate element of the intermediate element assembly is preferably provided as an elastic, naturally hard, nitrated or hardened intermediate element, for example in the fashion, or in an assembly or functional mode, according to a (formed) bushing. The (respective) intermediate element herein improves the wear assistance especially in at least one fixing point of the axle, specifically largely independently of the basic material. The intermediate element herein can also be composed of one or a plurality of layers of different materials. Hard layers herein offer an advantageously pronounced protection against wear, while soft layers can predominantly also ensure an elastic deformation, in particular without being in flux. To this extent, a correspondingly chosen material combination can also enable an advantageous functional integration in only a single intermediate element (multiple function). The person skilled in the art can determine here individually for the respective specific application in particular as a function of the materials of the axle and the receptacle which hardness ranges are in each case to be considered as relatively hard and as relatively soft.

The at least one intermediate element preferably has, on at least one outer (shell) face, a structuring which acts in a form-fitting manner and is specified to counteract an axial relative movement, in particular without an axial relative movement occurring. It has been demonstrated that a structure of this type, which acts externally in a planar manner, can effectively counteract here an axial displacement out of the axle bore (or a corresponding axial relative movement) both, or predominantly, in a form-fitting manner, preferably on at least one radially outer surface, as well as in a force-fitting/friction-fitting manner, preferably on at least one radially inner surface, on account of/due to corresponding structuring (laser structuring, structures that increase the coefficient of friction, additionally also nanostructure adhesion) (a materially integral fixing can additionally also be selectively provided, in the context of an additional securing feature, without this securing feature having to provide a high force flux). The corresponding intermediate element herein can selectively also be/have been embodied so as to be (simply) conical, multi-conical, in particular in the fashion of a dowel, or in a wave shape.

According to an exemplary type of implementation by increasing the coefficient of friction and/or by a wedge-shaped or helical surface on the inside of the (respective) intermediate element, the fit formed by the axle and the bore, or the receptacle, can also be expanded here, for example, as a result of which the deformation of the carrier module under load can also be reduced. The inside herein can counteract any uncontrolled frictional wear. As a result of the structuring, a comparatively hard surface structure can also be achieved here which cannot be dissolved (is not deformable to its original state) and which does not, or if at all only insignificantly, compromise the tolerances of the axle previously achieved usually by precision machining (or the tolerances required for a respective application).

One of the types of structuring described herein can selectively take place, or be provided, here on the respective intermediate element or else on the axle, and can be divided into zones across the circumference and/or axially in the direction of load and movement, and can accordingly be designed or configured/tailored so as to be stronger, weaker, impeding, or so as to have a reduced action in the joining direction. Within these zones, a line density, the direction of the structure and/or the intensity and shape of the structure can in particular be adapted to specific peculiarities and requirements of the respective axle contact. The present invention offers a comparatively high degree of variability also to this extent.

The intermediate element can have, for example, an integrated run-up face specified for a friction mounting between a planet gear and a planet carrier, and herein be embodied for example so as to be continuous, slotted or segmented. Here, a shape of the contact surface that has a spherical preliminary profile can also compensate any potential deformations caused in particular by the assembly procedure, for example. To this extent, the intermediate element can also be/have been implemented so as to act in the context of a compensation element.

The intermediate element can also be thickened or tapered on one side, in particular for the purpose of compensating positional tolerances of the axle receptacles (or carrier bores) by way of orientation during assembling. This not least also leads to improved load bearing capabilities of the carrier module. Alternatively, the axle bores can also be implemented in the already assembled state of the intermediate elements. To this extent, the present invention also offers a solution for different assembly situations that can be technically implemented.

In order, for example, to facilitate a deformation, the intermediate element (for example in the form of a type of dowel) can be slotted, perforated or segmented, be hardened or nitrated, and in the process be/have been embodied with and without a coating that facilitates assembling. The exemplary embodiments described here are not to be understood to be limiting also in this regard.

The axle receptacle, or carrier bore, herein can selectively be/have been shaped so as to be cylindrically straight, conical or spherical, or embodied with selectively also grooves for axially and/or tangentially securing the respective intermediate element.

The axle receptacle, or an axle seat to be structured, herein can preferably be/have been embodied so as to be cylindrical or else conical, helical or wave-shaped, in particular also with a view to a design embodiment which is self-locking in relation to twisting. Alternatively or additionally, the coefficient of friction in at least one axial portion or on at least one surface portion can be increased on the inside and/or the outside by chemical structuring, or selectively also by knurling measures (shaping according to a knurling), or by nanostructure adhesion. In particular in the event of the risk of a relative movement axially toward the outside, a static frictional force which acts in a particularly proportional manner can be additionally increased as a result.

Based on the intermediate element assembly described here, radial forces which advantageously steadily decrease can be ensured at the ends of the respective axle receptacle, or at bore ends, in particular as a result of a spherical comb profile (comb tips smoothed), wherein a retaining ring can be dispensed with, and wherein the available installation space for the axle fixing can also be extended in length/enlarged and can optionally advantageously be utilized for further use in terms of fixing length, or press-seat face. The intermediate elements can be used here on at least one side of the axle fixing, as mentioned, selectively in the same or in a mutually dissimilar design embodiment. As a result of the respective intermediate element, materials with similar characteristics (for example in terms of microstructure, hardness) can also be combined here with one another, which without an installed intermediate element could/would have a tendency in each case toward increased wear. To this extent, the present invention can be implemented in new products as well as in the context of service applications, and herein also increase the variability in terms of the materials that can be used, and minimize the complexity in terms of post-machining on the axle receptacle and/or the axle.

It has been demonstrated that the present invention can also ensure the following advantages: In comparison to previous pairings (axle with axle receptacle) there is no uncontrolled initial conditioning of the axle contact. This also has the effect of a noticeably lower material input into the oil and the gear unit. The avoidance of strain-hardened particles which may cause damage to the bearings or the toothing is in particular facilitated. The improved fixing, especially in a planetary transmission, reduces also radial and axial deformations of the planet carrier, for example, which in turn reduces the micro-movement during contact of the axles and thus contributes toward minimizing the frictional wear. Furthermore, structural components can now be more easily sized so as to be optimized in terms of weight. The supporting behavior of the module is improved as a result of the increase in stiffness achieved, wherein a more efficient sizing of the toothing and mounting is in particular also made possible. These measures are also directly associated with increases in output density. As a result of the aligning possibility of the intermediate element during assembling, mutual manufacturing variances of the carrier, or of the axle receptacle and of the axles can moreover also be compensated and optimized conditions can be set. As opposed to an embodiment having consistently tighter fits, the assembling is facilitated by the at least one intermediate element in particular in the case of a slotted, segmented or conical shape (no even greater enlargement of the bore than currently already required). The expansion can take place thermally or by impact driving or pulsed driving into the carrier, or into the axle receptacle, during assembling of the axle. The assembling can selectively also be implemented by way of thermally joining an integral intermediate element.

An axially fixed mounting herein is understood to mean in particular a mounting/fastening in which an axially fixed positioning of the contact partners is predominantly important, in combination with an axial force-transmitting effect, for example in response to bending moments acting on a/the planet carrier, and advantageously also a high torsional stiffness and a high torque transmission capability of the entire planet carrier assembly can be ensured; the axle is disposed or fixed in a form-fitting/force-fitting manner in a predefined axial target position in the axle receptacle, and herein defines, for example, a rotation axis for a planet gear which is guided by means of a/the planet carrier. The term “axially fixed” can therefore also comprise a co-rotational disposal of the axle within the axle receptacle; according to the present disclosure, the term “axially fixed” has been chosen because the task of minimizing axial relative movements is predominantly to be overcome for the applications envisaged, in particular with a view to receiving and transmitting comparatively high bending moments. Nevertheless, the advantages which are described here in the context of the axially fixed disposal can furthermore also be/have been developed by an improved torsional strength which is associated with the measures according to the invention.

Personified terms, unless worded in the neutral herein, may refer to all sexes in the context of the present disclosure. Any English expressions or abbreviations used here are in each case technical expressions customary in the respective sector and are familiar to the person skilled in the English language. Any German terms which are used/may be used synonymous thereto or otherwise may be stated in (brackets) for the sake of completeness here, or vice versa.

In gear units to date, disadvantages are often derived in terms of installation space length or high compression/contact forces and additional investment in terms of material and constructive scope of the gear unit caused thereby, or else in terms of a comparatively heavily restricted selection option in terms of materials that can be used. According to the invention, however, the knowledge that a functional decoupling can be ensured by means of an additional intermediate element assembly at the interface between the axle and the axle receptacle can also be utilized, as a result of which the respective material pairing can also be more easily optimized for a specific function without causing noticeable disadvantageous secondary effects in the process. If the respective intermediate element can be optimized specifically in terms of material, in particular on the inner contact side toward the axle as well as on the outer contact side toward the axle receptacle, the selection of material relating to the axle and/or the axle receptacle can be carried out more independently of any wear aspects. Moreover, the respective intermediate element can also assume the function of a reliable/robust and resilient axial securing feature or axial fixing, and in this regard minimize the risk of relative movements.

If reference is made according to the present disclosure to an axle receptacle in terms of the industrial gear unit, in the case of planet carriers this also refers in particular to axle bores in the planet carrier. However, the present disclosure relates generally to axle receptacles of any design embodiment, independently of the type of gear unit.

Individual exemplary embodiments will be discussed more specifically hereunder; the combinations of features described in each case hereunder can be combined with one another unless this is explicitly negated here.

According to one exemplary embodiment, the intermediate element assembly has at least one intermediate element which is mounted in an axially fixed manner between the axle and the axle receptacle in the (corresponding) axial portion, and which in at least one outer surface portion, thus at the axle receptacle, has an (in the case of a corresponding normal force also resilient in the axial direction) structured surface that acts in a form-fitting manner and preferably has a greater hardness than the corresponding surface of the axle receptacle, and in at least one inner surface portion, thus at the axle, has a structured surface that acts in a force-fitting manner. This differentiation in terms of the manner of the force-fitting and/or form-fitting interaction on the respective contact side also enables a functional focusing on the respective contact face such that the associated technical effects can in each case be generated at the interface that is particularly advantageous for the purpose. Also, the spectrum of the advantageous assembly options can also be kept as wide as possible as a result; for example, force-fitting connections on flat face portions (or cylindrical faces) can also implement an interference fit or press fit in a comparatively simple manner, also with comparatively little complexity in terms of assembling. The respective outer structured surface of the respective intermediate element is thus preferably a surface which is optimized for a form fit and in which the axial self-locking is/would be ensured also independently of a normal force. The respective inner structured surface is thus preferably a surface which is optimized for a force fit and in which the axial self-locking can be generated as a function of a normal force, or of the value of this normal force. In other words: the two shell faces of the respective intermediate element are preferably structured in a different manner (in particularly rougher on the outside and finer on the inside). According to a variant of this concept, the outer as well as the inner structured surface can both have in each case a comparatively rough structure and additionally also be provided here with a comparatively fine structure (as explained in more detail by way of example hereunder with reference to a design embodiment in the manner of an axle dowel/anchor, or of an inter-axle grommet), in the fashion of a functional redundancy thanks to rough as well as fine structures on both sides/shell faces. The axle can selectively also have a surface structure, in addition or alternatively to a/the surface structure on the inner shell face of the intermediate element.

“Form-fitting” here is understood to mean an axially fixed fixing, substantially based on geometric characteristics of the respective surface, wherein this type of action here is in particular also highlighted with reference to relatively rougher structures; figurative speaking, reference is made herein in particular also to a sawtooth profile or a fine thread or a knurling, in particular at the axle receptacle. The form fit herein can preferably already be ensured in that the corresponding shaping/geometry is pronounced on the intermediate element, thus not necessarily even on the axle receptacle per se. Anchoring by shaping can in this instance also be implemented thanks to different material hardnesses and thanks to comparatively high surface pressure, in particular in that the outer shell face of the intermediate element digs into, or is pressed into, the corresponding inner shell face of the axle receptacle. Accordingly, “form-fitting”, or “substantially by a form fit” is understood to mean a connection which is based substantially on a form fit in the sense of a macroscopically geometric tooting and can selectively also comprise a force fit (wherein an at least slightly proportional force fit can already be derived by different deformations and stresses on the contact faces, thus cannot/should not be entirely precluded).

“Force-fitting” and in the tighter sense “friction-fitting” or “static friction-fitting” (with reference to connections without any permissible relative movement) is understood to mean here in particular an axially fixed connection without the requirement of specific shaping or geometric unevennesses such as e.g. edges or shoulders or noticeable grooves or sawtooth profiles, wherein this type of action here is in particular also highlighted by reference to relatively fine/finer structures, in particular with reference to laser structures or laser-structured surfaces which can also (or specifically) be implemented on completely planar/flat surfaces (in particular cylindrical inner shell faces), on which shoulders or edges in the (macroscopic) geometric sense thus do not have to be present, but which can ensure adhesion/fixing according to a coefficient of static friction defined by the structuring in conjunction with a normal force. A force fit herein is ensured as a function of a specific normal force acting on the contact faces (whereas such a normal force is/would not necessarily be required in the case of a form fit). The present invention accordingly is also based on the concept of implementing different types of action of an axially fixed fixing on the contact partners or shell faces which are in each case particularly preferred for the purpose, in any case comprising a form fit based on laser structures in particular at the axle. Accordingly, “force-fitting” or “substantially by a force fit” is understood to mean a connection which is based substantially on a force fit and selectively can also comprise a form fit, or can be enhanced at least to a small proportion by a form-fitting type of action (for example if the intermediate element has comparatively rough structures or else a shoulder or a run-up face or disk or a similar contour). It can be seen therefrom that an interaction of these two types of action cannot be precluded per se in practice, and according to exemplary embodiments of the present invention may also be implemented simultaneously, depending on the design embodiment of individual intermediate elements, with reference to the same intermediate element, for example on the two shell faces. The present disclosure is accordingly also to be understood in such a way that when reference is made to a “force fit” the corresponding surface is provided or conceived or configured for a substantially force-fitting connection (here: in particular or preferably at least one inner face of the respective intermediate element that points toward the axle), and that when reference is made to a “form fit” the corresponding surface is conceived or configured for a substantially form-fitting connection (here: in particular or preferably at least one outer face of the respective intermediate element that points toward the axle receptacle). This differentiation offers the advantage of a high variability and individualization capability and thus of a great optimization potential for a respective gear unit, for example also in conjunction with different hardnesses or different layers of different materials. The force fit and/or form fit that is to be implemented on the respective shell face or interface herein does not necessarily have to be implemented by a measure on the part of the intermediate element but may also be implemented by a measure on the part of the axle and/or on the part of the axle receptacle, selectively exclusively, selectively in combination with a/the measure on the intermediate element. This functional differentiation will be explained even further and specifically visualized by the following illustrative exemplary embodiments.

The invention is also based here on the concept of designing the at least one intermediate element harder on at least one side (in particular on the outer surface) than the axle receptacle; in this way, the axle receptacle can be conceived with advantageous material characteristics largely independently of requirements pertaining to wear protection, and the function of the wear protection can be ensured by means of the intermediate element assembly. Thanks to the intermediate element assembly, machining the material on the axle receptacle and/or the axle is accordingly not required, or required only to a highly reduced extent. The intermediate element assembly can advantageously be provided in such a manner that a material selection and any potential post-machining on the axle and the axle receptacle can be performed in an ideally wide range of variants and flexibly in terms of other requirements than wear protection. The axle ends can optionally be/have been machined, for example. However, this is not necessarily required according to the invention. The axle can optionally be structured in an optimal manner for a force-fitting press fit on the outside, and also be embodied here so as to be comparatively hard (in particular martensitically hard), in particular by laser structuring.

For example, the respective intermediate element is designed with a comparatively rough structure for a form fit on the outside, and the axle is designed with a comparatively fine structure for substantially a force fit. Alternatively or additionally, the comparatively fine structure can also be provided on an inner shell face of the intermediate element.

According to one exemplary embodiment, the intermediate element assembly comprises at least one intermediate element in one of the following design embodiments: slotted sleeve, formed bushing, in particular with a run-up face (in particular L-shaped) and/or with an internal nut and/or in combination with a cone, inter-axle grommet, in particular conical, spherical, knurled, provided with a toothing, formed helical or wave-shaped. These variants, which will be described in yet more detail hereunder, offer in each case also a particularly advantageous disposal in specific applications, in particular in each case relating to a mounting of planet axles in a planet carrier of a planetary transmission.

A run-up face herein facilitates a relative axial positioning, for example of a planet gear, for example in that corresponding segments or contact points are provided. As opposed thereto, a separate run-up disk is to be considered as a rather cost-intensive solution in which an additional securing feature would be required. The concept according to the invention now also enables this optional functionality to be integrated in a comparatively simple and robust manner.

The axle per se is also preferably provided with a corresponding surface structure, in particular likewise with a comparatively fine surface structure corresponding to the inner surface of the respective intermediate element. An ideally hard material of the axle, for example martensitic hardness, is also particularly advantageous herein. A force-fitting press fit which adheres very well can be implemented on the inside of the intermediate element assembly as a result. The person skilled in the art can specify for a respective exemplary application whether also a respective axle should be present in a structured manner, or whether only the intermediate element is to be present in a structured manner.

The intermediate element assembly advantageously has at least one intermediate element specified for axially positioning a planet gear of the industrial gear unit, for example also in combination with an integrated run-up face. This functionality can also replace classic run-up disks (used as separate parts), or render them dispensable.

According to one exemplary embodiment, the intermediate element assembly comprises at least one intermediate element which has at least one layer of a material with a hardness dissimilar to the hardness of the material of the axle and/or of the axle receptacle. This not least also facilitates the targeted setting of a desired type of a substantially force-fitting adhesion by manipulating the surface characteristic of at least one shell face of the respective intermediate element.

According to one exemplary embodiment, the intermediate element assembly comprises an intermediate element which is designed as a slotted sleeve, wherein the structured surface for the form-fitting support in the axial direction in at least one axial portion is provided on the outside with a surface structure which acts in a form-fitting manner, in particular in the fashion of a sawtooth profile or a (fine) thread, or is designed in a knurled manner. This design embodiment is not least also distinguished by an advantageously simple basic shape and can be used for many different types of axle and axle receptacle pairings. The structured surface for the force-fitting support in the axial direction can in particular also be provided here so as to be superimposed with a rather macroscopic geometry in at least one axial portion on the inside with a surface structure which acts in a force-fitting manner, is incorporated by laser structuring and has increased coefficient of static friction. This enables very reliable, axially fixed contact also on the inside. In this design embodiment it can be advantageous when the axle is optimally structured for a force-fitting press fit on the outside, and in the process is also embodied so as to be comparatively hard (in particular martensitically hard), in particular by laser structuring, in particular so as to correspond to a/the inner surface structuring of the intermediate element. Selectively, both or only one of the at least two shell faces that bear on one another at the axle are or is surface-structured, thus either the inner shell face of the intermediate element or the (outer) shell face of the axle.

According to one exemplary embodiment, the intermediate element assembly comprises at least one intermediate element which is designed as a slotted sleeve or slotted formed bushing. This not least also facilitates the assembling, or widens the spectrum of assembling methods that can be used.

According to one exemplary embodiment, the intermediate element assembly comprises at least one intermediate element in the design embodiment as a sleeve or formed bushing, in each case having an integrated run-up face or contour, wherein the structured surface for the form-fitting support in the axial direction in at least one axial portion is provided on the outside with a surface structure which acts in a form-fitting manner, in particular in the fashion of a sawtooth profile or a thread, or is in a knurled manner, wherein the sleeve or formed bushing has a friction bearing-coated run-up face preferably on the end side, or a friction bearing-coated collar. This design embodiment not least also favors an integration at an interface between the planet carrier and planet axles, and can also advantageously minimize the friction, or the wear, on at least one end side. The structured surface for the force-fitting support in the axial direction in at least one axial portion can be provided herein on the inside with a surface structure which acts in a force-fitting manner, is incorporated by laser structuring and has an increased coefficient of static friction. This also enables a very reliable axially fixed adhesion in relation to axial relative movements on the inside, without the corresponding shell face having to be provided with an additional geometric shaping (in macroscopic terms) for this purpose. This not least also has advantages in terms of ideally extensive possibilities in terms of assembling/joining. Selectively, both or only one of the at least two shell faces that bear on one another at the axle are or is surface-structured, thus either the inner shell face of the intermediate element or the (outer) shell face of the axle.

According to one exemplary embodiment, the intermediate element assembly comprises at least one intermediate element which is designed as a sleeve or formed bushing comprising a surface structure in the fashion of a sawtooth profile or a thread or a knurling. This structure can also be predefined here as a function of a specific shell face and/or specific axial position, in particular also in combination or in superimposition with the laser structure described here.

According to one exemplary embodiment, the intermediate element assembly comprises an L-shaped formed bushing, in particular an L-shaped formed bushing with an internal nut or in combination with a cone, wherein the structured surface for the form-fitting support in the axial direction in at least one axial portion is provided on the outside with a surface structure which acts in a form-fitting manner, in particular in the fashion of a sawtooth profile or thread, or is provided in a knurled manner, wherein the formed bushing is preferably friction bearing-coated on the end side, wherein the formed bushing is secured in the axial direction on the axle by means of a/the internal nut and/or by means of a/the cone. As a result, further advantages relating to the installation situation cannot least also be achieved; for example, a retaining ring can be dispensed with in planetary transmissions. The structured surface for the force-fitting support in the axial direction in at least one axial portion can be provided here on the inside with a surface structure which acts in a force-fitting manner, is incorporated by laser structuring and has an increased coefficient of static friction. This also enables a very reliable axially fixed adhesion in relation to axial relative movements on the inside. A/the cone, which is provided in combination with the formed bushing, can be provided here as a conical axle seat, in particular on the opposite axle end of an axle bordered on two axial portions. A design embodiment of this type also offers the advantage of a very effective axial load transmission (in particular in the context of relieving the further mutually contacting shell faces) on one of the axle ends, in particular in conjunction with a comparatively simple/advantageous assembling. Selectively, both or only one of the at least two shell faces bearing on one another at the axle are or is surface-structured, thus either the inner shell face of the intermediate element or the (outer) shell face of the axle.

According to one exemplary embodiment, the intermediate element assembly comprises at least one intermediate element which is designed as a formed bushing in combination with an internal nut or a cone. As a result, the component combination of axle receptacle and axle can optionally also be equipped with additional functionality, in particular in a manner specific to the axial position (for example on only one of the axle ends).

According to one exemplary embodiment, the intermediate element assembly has a cone, which is provided in combination with a formed bushing, as a conical axle seat, in particular on the opposite axle end of an axle bordered on two axial portions. This offers an advantageous manner of combining components of the axle receptacle and the axle, in particular in the case of a planet gear which is bordered by the planet carrier on both sides.

According to one exemplary embodiment, the intermediate element assembly comprises at least one intermediate element in the design embodiment as a conically shaped inter-axle grommet, wherein the structured surface for the form-fitting support in the axial direction is provided on an/the inside as well as on an/the outside of the inter-axle grommet and is provided with a surface structure which acts in a form-fitting manner, in particular in the fashion of a multi-conical sawtooth profile on both sides for a helical toothing, and wherein a relatively finer structure comprising a surface structure which acts in a force-fitting manner, is incorporated by laser structuring and has an increased coefficient of static friction, and selectively also a surface structure generated by chemical structuring and/or structure surfaces connected to one another by cold welding in particular based on nanostructure adhesion is preferably also provided inside as well as outside (in particular inside as well as outside, for the purpose of functional redundancy on both contact faces on the inside and outside), for example in mutual combination at different axial positions and/or different shell faces. This not least also enables an advantageous combining or combination of force-fitting and form-fitting adhesive effects on the inside as well as on the outside. A/the intermediate element of the intermediate element assembly, which is designed as a conically shaped inter-axle grommet, can also have a spherical comb profile here. As a result, a deformation compensation effect, or tolerance compensation effect not least can also be functionally integrated, and the assembling can be facilitated. Selectively, both or only one of the at least two shell faces that bear on one another at the axle are or is surface-structured, thus either the inner shell face of the intermediate element or the (outer) shell face of the axle.

According to one exemplary embodiment, the intermediate element assembly has at least one intermediate element with an outer relatively rougher structure, wherein the relatively finer laser-structured surface is provided at the axle, selectively on the axle and/or on the intermediate element. This functional division between the at least substantially force-fitting axially fixed type of action, or connection inside, and the predominantly or at least significantly also form-fitting axially fixed connection on the outside not least also offers a positive compromise between implementability in terms of manufacturing technology and realizability in terms of the specific application, while also taking into account expedient material pairings and material hardnesses.

According to one exemplary embodiment, the intermediate element assembly, or an individual intermediate element thereof, is formed from a plurality of layers, in particular from a plurality of layers having in each case different/individual (local) hardness (for example caused by different local hardening processes), or from different materials or material pairings having in each case different/individual hardness, in particular also dissimilar to the hardness of the material of the axle or of the axle receptacle. This also offers further variation possibilities in terms of material and hardness pairings at the contact faces, and therefore an even greater individualization capability. For example, micro-movements can be effectively absorbed by means of a comparatively soft core of the intermediate element, thus in that a comparatively harder, more wear-resistant structure is provided on the outside (in at least one outer layer). The person skilled in the art can also decide with a view to advantageous materials of the axle and the axle receptacle, for example, whether a plurality of layers or a plurality of materials (material layers) are to be provided advantageously, and which specific hardness is to be provided in each case. Variations in this context are also to be implemented so as to be geared heavily toward the specific application.

According to one exemplary embodiment, within at least one structured surface portion of the (respective) intermediate element, a line density and/or direction of the structure and/or intensity and shape of the structure is individualized. This not least also enables an even more specific conception in terms of local contact conditions, for example in terms of surface pressure, direction of acting force, or the like.

According to one exemplary embodiment, the industrial gear unit is designed as a planetary transmission in which a/the (respective) axle receptacle is provided, in particular in the form of a planet carrier bore, in a planet carrier of the planetary transmission, wherein on the respective axle receptacle at least one intermediate element of the intermediate element assembly is disposed on at least one shell face at least substantially in a force-fitting manner in relation to an axial relative movement between the planet carrier, or the axle receptacle, and the axle, or acts there in a wear-reducing or wear-preventing manner. The present invention cannot least also be implemented in a particularly advantageous manner in planetary transmissions with a comparatively high number of planets or planet axles, in particular without the high number of planets having a negative effect on the stiffness. The planet carrier herein is designed as a casting, for example; the casting material herein can be chosen largely independently of the at least one material of the at least one intermediate element.

According to one exemplary embodiment, the industrial gear unit is installed in a power train of a wind power installation, or especially configured for this purpose, specifically in the form of a planetary transmission, or comprising at least one planetary transmission stage. This application in a comparatively highly stressed and dynamic power train in the sector of wind power generation in particular offers herein the advantageous wear-reducing effects described here in a particularly noticeable and sustainable manner.

According to one exemplary embodiment, the respective axle is mounted in an axially fixed manner in two axial portions in the axle receptacle, wherein the respective axle by means of a first intermediate element of the intermediate element assembly is mounted in an axially fixed manner in a first axial portion, and by means of a second intermediate element of the intermediate element assembly is mounted in an axially fixed manner in a second axial portion, wherein the intermediate elements on at least one inner surface bear in each case on the axle in an at least or substantially force-fitting manner and on at least one outer surface bear in each case on the axle in an at least or substantially form-fitting manner; wherein the first and second intermediate element are selectively of the same type or of different types, in particular selected from the following groups of intermediate element types: sleeve, selectively with run-up face, formed bushing selectively in combination with internal nut and/or cone. This variability has proven advantageous in particular also in the context of different types of highly stressed planetary transmissions with a comparatively high number of planets and an axially fixed mounting of the individual planet axles. The axial force-transmitting action on both axial portions is advantageously set here so as to be at least approximately identical (effect of the measures according to the invention), wherein the manifestation and/or distribution of the structures across the circumference and/or in the axial direction can however be implemented here in a different or individual manner for each axial portion.

According to one exemplary embodiment, the respective axle is mounted in an axially fixed manner, and thus in an axial force-transmitting manner, in two axial portions in the axle receptacle on both sides of the corresponding planet gear, in particular in such a manner that the planet gear is able to be axially positioned by at least one of the intermediate elements by means of a run-up face. This not least also facilitates maintaining the desired stiffness largely independently of the period of use/operating period/service life, or largely independently of potential wear-related aspects, in particular independently of play or else only minute relative movements (which can in each case be at least almost precluded). The respective axial force can at least be substantially, selectively also exclusively, transmitted here to the axial portions defined by means of the respective intermediate element. Cold-welding can selectively also be implemented here on at least one of the axial portions.

One aspect furthermore relates to a production method for intermediate elements for industrial gear units in the form of a planetary transmission having wear-minimized or wear-preventing components, comprising the intermediate element assembly described previously further above, for example in a disposal in a power train of a wind power installation. The previously mentioned object is to this extent also achieved by a method according to the corresponding coordinate method claim, specifically by a method for producing an intermediate element assembly for use in an industrial gear unit in the form of a planetary transmission (for example of a wind power installation) in at least one axial portion between at least one axle and at least one axle receptacle for the axially fixed mounting of the axle in the axle receptacle, in particular for use on a planet carrier of the planetary transmission, wherein in at least one surface portion of at least one intermediate element of the intermediate element assembly a structured surface comprising at least one (axial force-transmitting) laser-structured surface which is specified for the at least substantially force-fitting and selectively also form-fitting support in relation to axial displacement, is incorporated at the axle and/or at the axle receptacle, in particular at least comprising laser structuring an inner surface specified for a force fit. Above-mentioned advantages are derived as a result, in particular in terms of a minimized complexity in terms of costs/manufacturing and greater variation possibilities also for other gear unit components, in particular for the axle and the axle receptacle.

According to one embodiment, in at least one surface portion of an inner surface/shell face of the at least one intermediate element a surface acting in a substantially force-fitting manner is incorporated by at least one of the following steps: laser structuring, chemical structuring, and selectively additionally also cold welding for microstructure and/or nanostructure adhesion, in particular on further axial portions and/or shell faces. This also enables an optimized connection not only on the outer shell face but also on the inner shell face in a different prioritization of the type of adhesive effect, specifically force fit or friction fit. The structured surface herein is preferably generated as a function of at least one predefined/predefinable specific relief and/or density parameter, in particular in a wave-shaped or serpentine or meandering structure, or in an imbricated structure, in particular having microscopic undercuts and without predefined spatial alignment, thus in a largely aleatory alignment. This not least widens the possibilities of individualization and also facilitates a type of standardization when incorporating very specific surface structures or roughness characteristics.

Laser structuring enables here in particular a very specific concept/design at least of the inner shell face of the intermediate element, in particular based on parameter variations relating to a specific coefficient of static friction, for example in terms of the depth/height and arrangement density of the structure and in terms of the profile shape of the lasered roughness profile, and also the normal force, thus an actual installation situation. It has been demonstrated that the laser structuring is of great use in particular also for the interface between planet axles and planet carriers, not least thanks to the high quality and process reliability and reproducibility, so that the type of mounting the individual planets is not implemented with mutual variance, but an identical design and identical operating conditions can be ensured for all planets and carrier bores. Laser structuring in particular enables very precisely definable dimensions and relative positions of the individual structure segments and for larger volumes can also be automated and integrated here in further manufacturing processes in a comparatively simple manner.

According to one embodiment, in at least one surface portion of an outer surface/shell face of the at least one intermediate element a surface acting in a substantially form-fitting manner is incorporated by at least one of the following steps: sawtooth profiling, fine thread tapping. This not least also facilitates a very reliable connection between a comparatively hard intermediate element and a comparatively soft axle receptacle, for example a planet carrier designed as a casting.

The corresponding component pairing can be expanded when incorporating at least one intermediate element of the intermediate element assembly between the axle and the axle receptacle. This results in further advantages not only in terms of assembling but also in terms of deformation behavior in particular in comparison to classic, comparatively tight fits.

The above-mentioned object is also achieved by an intermediate element assembly for an industrial gear unit in the form of a planetary transmission, having at least one axle and at least one axle receptacle for mounting the axle, wherein the intermediate element assembly is specified for disposal between the axle receptacle and the axle, wherein at least one intermediate element of the intermediate element assembly is produced by at least one of the following steps: providing a basic shape of a preferably integral main body of a separate intermediate element specified for disposal in a wear-reducing or wear-preventing manner between the axle and the axle receptacle, incorporating at least one structured surface, which is specified for the form-fitting and selectively also force-fitting support in relation to an axial relative movement, in at least one surface portion of at least one intermediate element of the intermediate element assembly by laser structuring or selectively also incorporating at least one structured surface by chemical structuring or selectively also cold welding for microstructure and/or nanostructure adhesion, in particular at least inside at the axle, and selectively also on further axial portions and/or shell faces, and selectively also incorporating at least one structured surface, which is specified for form-fitting support in relation to an axial relative movement, in at least one surface portion of at least one intermediate element of the intermediate element assembly by sawtooth profiling or fine thread tapping, in particular at least on the outside at the axle receptacle; in particular produced by a method which is described previously further above here or in the context of the figures. Aforementioned advantages can be implemented as a result, in particular also in terms of independent manufacturing and logistics chains and the high component-specific degree of individualization capability already mentioned multiple times above.

The aforementioned object is also achieved by the use of an intermediate element assembly in an industrial gear unit between an axle and an axle receptacle for mounting the axle, specifically in a planetary transmission (for example in a planetary transmission stage with a comparatively high number of planets), wherein at least one intermediate element of the intermediate element assembly by way of at least one outer shell face which is specified for a form fit and has a form-fitting contour in at least one outer shell face portion, comes to bear in a form-fitting manner in the axle receptacle, wherein at least one intermediate element of the intermediate element assembly by way of at least one inner shell face, which is specified for a force fit and has a laser-structured structure acting in a force-fitting manner in at least one inner shell face portion, comes to bear in a force-fitting/friction-fitting manner on the axle, in particular having the intermediate element assembly comprising at least one intermediate element in the form of a sleeve or a formed bushing, each having a run-up face, in particular for already existing and installed gear units/gear unit components, in particular in at least one planetary transmission stage of a power train of a wind power installation, in particular by the corresponding use of an intermediate element assembly described previously further above. Aforementioned advantages can be implemented as a result, in particular also in terms of an efficient/effective functional assignment of axially securing parameters among individual contact faces, or separate components.

The aforementioned object is also achieved by the use of at least one intermediate element of an intermediate element assembly in an industrial gear unit in the form of a planetary transmission (for example in a planetary transmission stage with a comparatively high number of planets) between an axle and an axle receptacle for mounting the axle, in particular in each case in one or two axial portions between planet axles and a planet carrier of the planetary transmission, wherein the at least one intermediate element of the intermediate element assembly by way of at least one outer shell face, which is specified for a form fit and has an in particular sawtooth-type or fine thread-type form-fitting contour in at least one outer shell face portion and has a relatively greater hardness than the axle receptacle, sits in a form-fitting manner in the axle receptacle, wherein the at least one intermediate element by way of at least one inner shell face, which is specified for a force fit and has a laser-structured surface acting in a force-fitting manner in at least one inner shell face portion, sits in a force-fitting/friction-fitting manner on the axle, wherein the at least one intermediate element is/has been preferably assembled thermally and/or by impact driving into the axle receptacle, in particular having the at least one intermediate element in the form of a sleeve or formed bushing or inter-axle grommet, each having a run-up face, in particular in at least one planetary transmission stage of a power train of a wind power installation, in particular by the corresponding use of an intermediate element assembly described previously further above. Aforementioned advantages can be implemented as a result, in particular in terms of numerous advantages not only in terms of construction and wear, but also in the overall context of assembling the components of an industrial gear unit.

Summary: The present invention relates to an industrial gear unit having at least one axle and at least one axle receptacle for mounting the axle in an axially fixed manner, wherein the axle is mounted in an axially fixed manner in at least one axial portion in the axle receptacle; wherein an intermediate element assembly is provided between the axle receptacle and the axle in a manner acting in the/in the at least one axial portion, which is mounted in an axially fixed and in an axial force-transmitting manner between the axle and the axle receptacle and which in at least one surface portion at the axle and/or at the axle receptacle has a laser-structured surface and as a result is specified for the at least substantially force-fitting and selectively also form-fitting support in relation to axial displacement, wherein a conical press fit or similar connection, which implements a form fit which is ensured rather on a macroscopic level, can additionally also be provided. The present invention furthermore also relates to corresponding intermediate elements having laser-structured surfaces for such an intermediate element assembly, and to production methods therefor and the use thereof in planetary transmissions, or planetary transmission stages with a comparatively high number of planets, in particular for wind power installations.

### BRIEF DESCRIPTION OF THE FIGURES

The invention will be described in more detail by way of example by means of preferred exemplary embodiments in the following figures of the drawing, wherein the features illustrated hereunder can represent an aspect of the invention in each case individually as well as in combination, and wherein reference to reference signs that are not explicitly described in a respective figure of the drawing is made to the other figures of the drawing. In each case in a schematic illustration:

FIG. 1 shows components of an industrial gear unit having an intermediate element assembly according to exemplary embodiments, in a sectional lateral view;

FIGS. 2A to 2F show views of components of an industrial gear unit, or of an intermediate element assembly used therein, according to an exemplary embodiment;

FIGS. 3A to 3C show views of components of an industrial gear unit, or of an intermediate element assembly used therein, according to a further exemplary embodiment;

FIGS. 4 and 5 show components of an industrial gear unit having a wear-preventing intermediate element assembly according to further exemplary embodiments, in each case in a sectional lateral view;

FIGS. 6A, 6B show views of components of an industrial gear unit, or of an intermediate element assembly used therein, according to a further exemplary embodiment;

FIGS. 7A to 7E show a perspective view and three lateral views, each of components of an industrial gear unit, or of an intermediate element assembly implemented therein, according to a further exemplary embodiment;

FIG. 8 shows individual steps of a method for producing an intermediate element assembly according to exemplary embodiments.

### DETAILED DESCRIPTION OF THE FIGURES

The invention will first be explained with general reference to all reference signs and figures. Particularities or individual aspects or aspects of the present invention which are readily visible/representable in the respective figure will be individually discussed in the context of the respective figure.

Provided is an intermediate element assembly 10 comprising at least one intermediate element 10a having structured surfaces 10.1, specifically at least one radially outer surface portion 10.1a (in particular a structured outer shell face) and at least one inner surface portion 10.1b in the radial direction (r) (in particular a structured inner shell face), wherein the structured surfaces 10.1 comprise form-fitting portions 10.3a (at least one) and force-fitting portions 10.3b (at least one).

In an assembly of the (respective) intermediate element 10a installed between an axle 101 and an axle receptacle 103, the structured surfaces 10.1 can ensure an axially fixed form-fitting/force-fitting connection 20 in the axial direction (x) between the axle and the axle receptacle, for example in an industrial gear unit 100 comprising at least one planetary transmission stage, in particular in an assembly between corresponding planet axles and planet carrier bores. A very effective protection against wear, in particular also at the interface between a planet carrier 105 and the planet gears 107 which are guided thereby in a revolving manner in a planet ring gear 109, can also be provided to this extent in a comparatively simple manner, wherein this wear protection also remains so as to be able to be individualized in a comparatively simple and variable manner for specific fields of application.

It has been demonstrated that a particularly advantageous design embodiment of the intermediate element assembly can be achieved in that the respective intermediate element in at least one outer surface portion (in particular on an outer shell face), thus at the axle receptacle, has a structured surface which acts in a form-fitting manner and has a comparatively rough shaping/structure (in particular a sawtooth profile against axial migration, or a type of fine thread contour), which preferably has a higher hardness than the corresponding surface of the axle receptacle, and in at least one inner surface portion (in particular on an inner shell face), thus at the axle, has a structured surface which acts in a force-fitting manner and has a comparatively fine laser structure (and selectively also chemically structured and/or cold-welded in particular for microstructure and/or nanostructure adhesion, in particular on further axial portions and/or shell faces). The respective intermediate element herein can in particular be provided in one of the following forms (which are able to be combined with one another in the case of a plurality of axial portions X1, X2 of the axle to be mounted): slotted sleeve or formed bushing, in particular with an integrated run-up face and/or with an internal nut and/or in combination with cone, inter-axle grommet, in particular of conical shape.

For example, the intermediate element 10a is provided in the form of a sleeve 11, in particular as a slotted sleeve comprising at least one slot 11.1. A run-up face or disk 12 can also be selectively provided on the sleeve, in particular having at least one friction bearing-coated surface or end side 12.1 and/or having radial slots or similar cutouts 12.3.

For example, the intermediate element 10a is provided in the form of an L-shaped formed bushing 13, in particular with an internal (groove) nut 14.1 and/or in combination with a cone 14.3 (conical axle seat, in particular in the case of two axial portions X1, X2 each provided with one intermediate element). The L-shaped formed bushing preferably has at least one friction bearing-coated surface 13.1, or end side. The formed bushing herein can also be provided with an internal (groove) nut, selectively also in combination with a cone, largely independently of the geometry chosen in the individual case.

For example, the intermediate element 10a is provided in the form of an inter-axle grommet 15 (in particular conically shaped), or as an axle dowel or axle anchor, wherein the structured surfaces are provided on an/the inside as well as on an/the outside and are provided with a surface structure which acts in a form-fitting manner, in particular in the fashion of a multi-conical sawtooth profile on both sides, wherein a relatively finer structure comprising a surface structure which acts in a force-fitting manner and has an increased coefficient of static friction, in particular as a result of laser structuring and selectively also by chemical structuring and/or cold welding for microstructure and/or nanostructure adhesion is preferably also provided inside as well as outside, in particular on further axial portions and/or shell faces. For example, a conically shaped inter-axle grommet is provided with a spherical comb profile. Selectively, both shell faces or only one of the at least two shell faces that bear on one another at the axle are or is surface-structured, thus either the inner shell face of the intermediate element or the (outer) shell face of the axle.

The present invention also relates to a production method relating to individual intermediate elements (in particular the types described in detail here), or a/the intermediate element assembly, or a wear-reduced industrial gear unit equipped therewith. In a first step S1, a basic shape, or a preferably integral main body of an intermediate element 10a (which can be separately provided), which in particular by virtue of the material and/or the hardness and the structuring to be performed thereon is specified for the wear-reducing or wear-preventing disposal between the axle and the axle receptacle is provided. In a further step S2, a structure which acts in a form-fitting manner is incorporated in at least one outer surface portion 10.1a, in particular by sawtooth profiling or fine thread tapping. In a further step S3, a structure which acts in a force-fitting manner is integrated in at least one inner surface portion 10.1b, in particular by laser structuring and/or by chemical structuring and/or cold welding for microstructure and/or nanostructure adhesion (chemical structuring and/or cold welding in particular also on further axial portions and/or shell faces). Subsequently, in a further step S4, a respectively desired intermediate element can be provided and be assembled between the axle and the axle receptacle for example by the steps mentioned elsewhere herein, for example also in gear units that are already installed or in operation.

Particularities of the invention will be explained hereunder with reference to individual figures or exemplary embodiments.

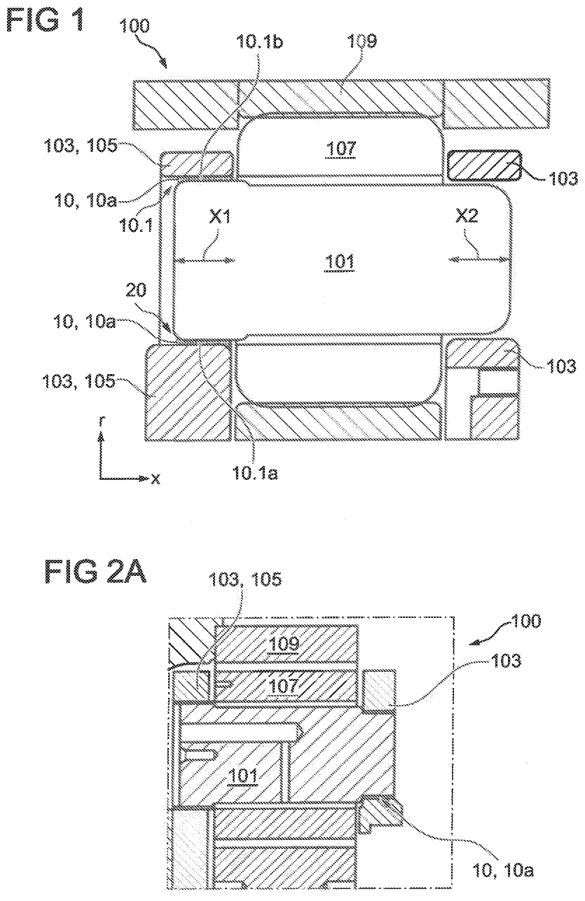

Shown in FIG. 1 is an exemplary application/use of the intermediate element assembly 10 according to the invention (by way of example, a single intermediate element 10a is indicated at one of the ends of the axle herein), with reference to a planet carrier 105 having an axle receptacle 103 and planet axles 101 which are in each case mounted thereon in an axially fixed manner in one or two axial portions. The respective planet gear 107 is held in a predefined axial position and guided so as to revolve in the planet ring gear 109 by means of the planet carrier 105. Different exemplary embodiments are shown in the following figures, which can also be implemented in a gear unit, or in an installation situation as shown in FIG. 1, for example, selectively on one axle end or both axle ends, or contact regions between the axle and the axle receptacle. As already explained further above, the installation situation can selectively also be chosen in a different way, for example at another location or in another type of gear unit.

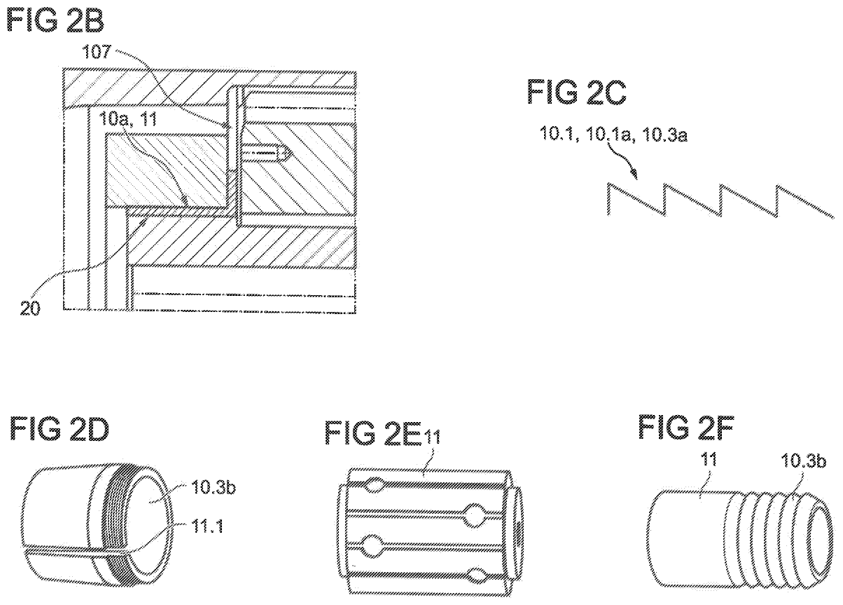

A design embodiment of at least one intermediate element 10a of the intermediate element assembly 10 as a slotted sleeve is visualized in FIGS. 2A to 2F: The intermediate element 10a is present in the form of a sleeve having an outer form-fitting surface (in particular a sawtooth profile or fine thread) and is anchored in relation to the (axial) disengagement direction between the axle and the axle receptacle, wherein the sleeve is preferably hardened or nitrated. The outer shell face of the sleeve can be pressed into the axle receptacle (for example a bore in a casting) and provide a wear protection for the axle receptacle (for example for a planet carrier made of a casting, or for a cast carrier). A force-fitting press fit, having preferably a laser-structured surface, is provided on the inner shell face of the sleeve at the axle, wherein the surface is preferably martensitically hard. The intermediate element 10a herein provides at least one at least substantially form-fitting connection on the radially outer contact face, and at least one at least substantially force-fitting connection with a high coefficient of friction on the radially inner contact face (in particular a laser-structured inner shell face). The sleeve consists, for example, of a sheet-metal material (bent), or is made as a sleeve, wherein the positional tolerance of the axle connection can remain at least approximately identical.

Shown in FIG. 2A is an intermediate element assembly 10 comprising two intermediate elements 10a, designed as a sleeve 11 (or based on the basic shape of a sleeve), in two different axial portions at the two ends of a/the planet axle. Shown in FIG. 2B is a detailed view of one of the two axial portions that are mounted in a wear-reduced manner. A/the surface structure of an outer shell face of the corresponding intermediate element 10a is visualized in FIG. 2C, specifically a sawtooth profile having a form fit which is greater/stronger toward the left than toward the right (thus in a force directed toward the left in the view of FIG. 2C). Shown in FIG. 2D is a first exemplary embodiment of a sleeve-type intermediate element, wherein the intermediate element has a slot 11.1, or is continuously slotted in the axial direction. Shown in FIG. 2E is a further exemplary embodiment of a sleeve-type intermediate element. Shown in FIG. 2F is a further exemplary embodiment of a sleeve-type intermediate element in which the structured outer surface is present only across a portion (approximately 50%) of the absolute length of the outer shell face, specifically in a portion which lies further axially inward in an intended disposal about the axle.

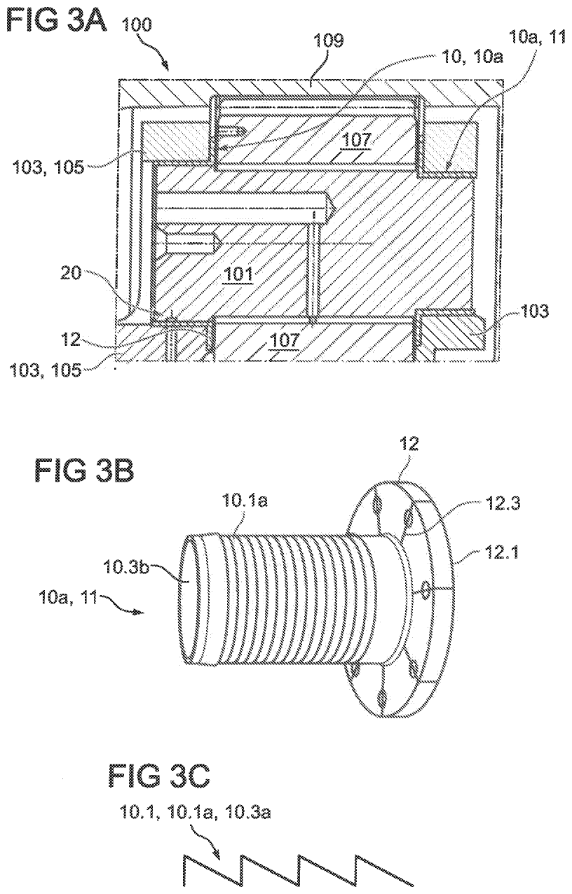

A design embodiment of at least one intermediate element 10a of the intermediate element assembly 10 as a sleeve with an integrated run-up face is visualized in FIGS. 3A to 3C: The intermediate element 10a is present in the form of a sleeve having an outer form-fitting surface (in particular sawtooth profile or fine thread) and is anchored in relation to the (axial) disengagement direction between the axle and the axle receptacle, wherein the sleeve is preferably hardened or nitrated. The outer shell face of the sleeve can be pressed into the axle receptacle (for example bore in the casting) and provide a wear protection for the axle receptacle (for example for a planet carrier made of a casting, for example for a cast carrier). The end face of the sleeve is preferably friction bearing-coated. A force-fitting press fit, having preferably a laser-structured surface, is provided on the inner shell face of the sleeve at the axle, wherein the surface is preferably martensitically hard. The sleeve can be present in a slotted form and fulfill a multiplicity of functions, in particular a form-fitting wear protection on the axle receptacle (for example a cast carrier) and provide carrier material for laser-welding or overlay welding of a/the run-up contour. In the process, precision machining can be dispensed with in particular in terms of a width across flats on the run-up contour and the axle receptacle (only a flat mirror plane), and an assembly which is secured against twisting can be provided in a comparatively simple manner.

An embodiment having two sleeves, which are installed in a mirror image of one another and have an integrated run-up face, is visualized in FIG. 3A. The structured outer shell face 10.1a (which is present over the at least approximately entire length) and the run-up face portion 12 are shown in detail in FIG. 3B, wherein the run-up face portion has at least one friction bearing-coated end side 12.1 and a multiplicity of radial slots 12.3 with stress-relief bores. A/the surface structure of an outer shell face of the corresponding intermediate element 10a is visualized in FIG. 3C, specifically a sawtooth profile having a form fit which is greater/stronger toward the left than toward the right.

The design embodiment of the respective intermediate element 10a described as a sleeve here can in particular also be disposed herein in the manner of a clamping connection between the axle and the axle receptacle.

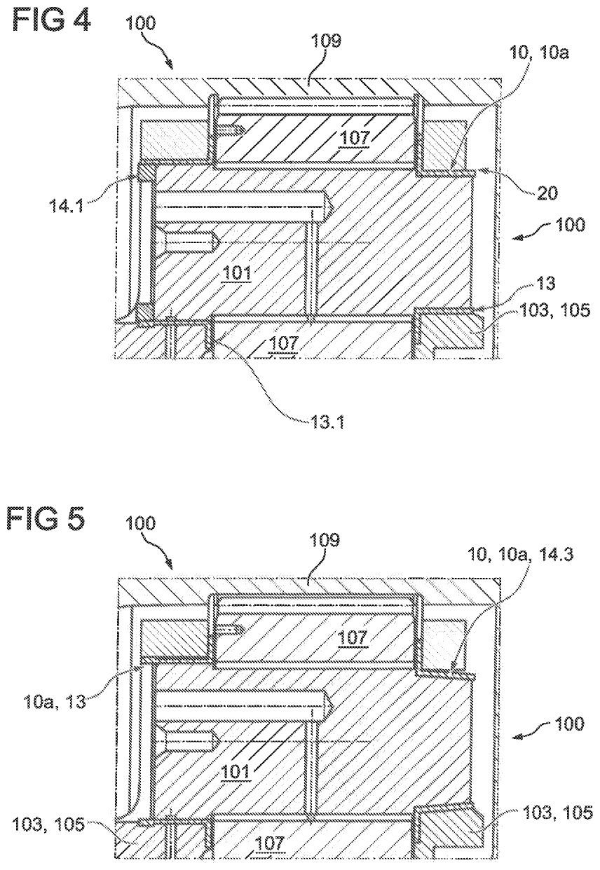

A design embodiment of at least one intermediate element 10a of the intermediate element assembly 10 as an L-shaped formed bushing having an internal groove nut is visualized in FIG. 4: The formed bushing with the groove nut 14.1 has an outer shell face which is designed so as to be form-fitting (in particular with a sawtooth profile or a fine thread) and in the process is secured in relation to the axial disengagement direction and is preferably composed of hardened or nitrated material. The outer shell face of the L-shaped formed bushing can be pressed here into the axle receptacle (for example bore in the casting) and provide a very effective wear protection for the axle receptacle (for example for a planet carrier made of a casting, or for a cast carrier). A/the end side is preferably coated in the manner of, or with a view to, the functionality of a run-up disk (in particular in the manner of a friction bearing coating). A retaining ring of the axle herein can advantageously also be dispensed with, for example. An axial load can be transmitted by a force fit on at least one inner face (preferably by means of a laser structure, in particular in the fashion of a sawtooth), wherein axial securing can be performed by a/the internal groove nut in the formed bushing. Preloading of the axle can be set or performed hydraulically. A slotted design embodiment can selectively be provided in conjunction with a conical bore, wherein the respective run-up contour is preferably spherically profiled for effectively providing a plastic defamation.

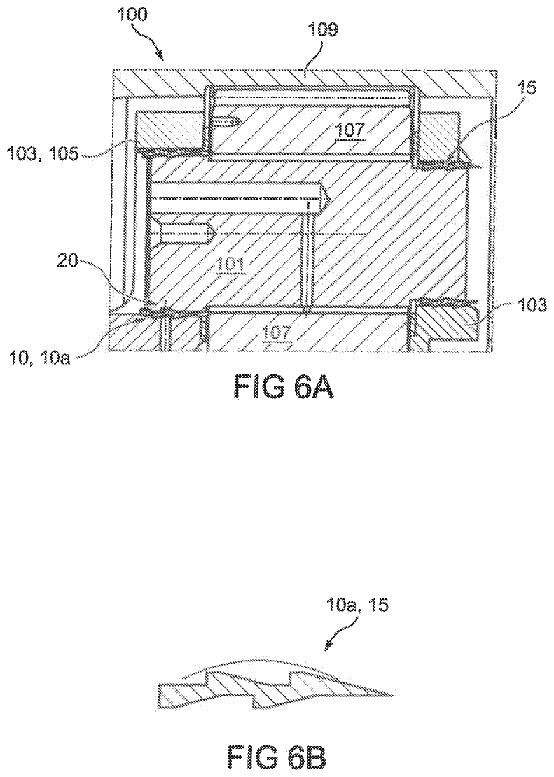

A design embodiment of at least one intermediate element 10a of the intermediate element assembly 10 as an L-shaped formed bushing in combination with a cone 14.3 is visualized in FIG. 5: Even comparatively high axial loads can be transmitted in a very reliable/robust manner by means of a/the conical axle seat, wherein the cone can be of a self-locking design, or can be secured in relation to extraction/outward migration by a corresponding securing feature. A corresponding ring can be slotted in the manner of a circlip. A relief groove can selectively be provided. The design embodiment according to FIG. 5 also visualizes that the present invention is also able to be optimized individually for specific applications in a comparatively variable manner as a function of different requirements set for an axial securing feature, or for the capability of transmitting comparatively high axial loads.

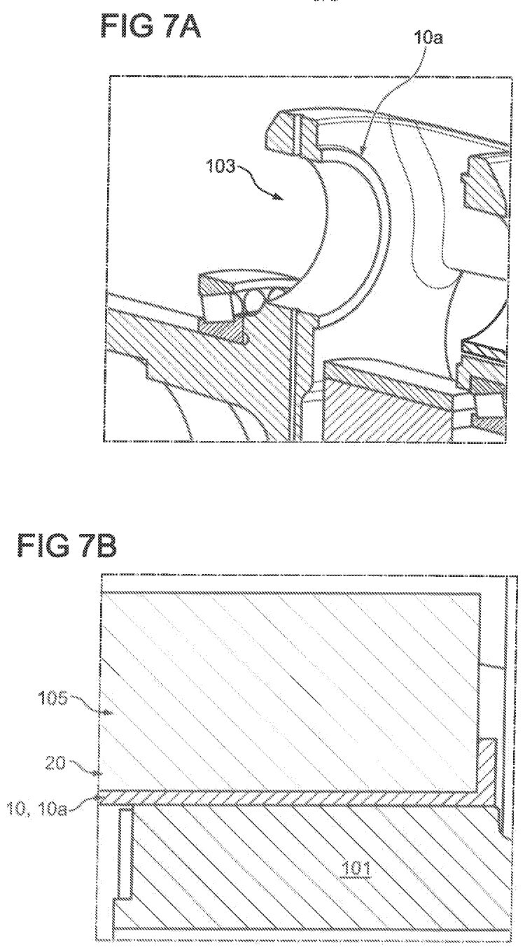

A design embodiment of at least one intermediate element 10a of the intermediate element assembly 10 as a conically shaped inter-axle grommet 15 is visualized in FIGS. 6A and 6B: The inter-axle grommet (also referred to as axle dowel or axle anchor according to the present disclosure, wherein the term “dowel” here is intended to refer in particular to the form-fitting contour), in particular in a slightly conical design embodiment, can lead to a local plastic deformation of the axle receptacle or carrier bore due to the axle being impact driven, and can expand the material of the internal-axle grommet, or the dowel material. As intended, the form fit is predominantly present here between the axle receptacle and the axle grommet/dowel (thus on the outer contact face of the intermediate element) so that the assembly is secured in relation to axial extraction/migration. Disassembly can take place, for example, by unscrewing helical dowels and/or by means of pressurized oil (hydraulically). The intermediate element herein however nevertheless acts predominantly in a force-fitting or friction-fitting manner (in particular inside as well as outside), wherein the radial forces at the ends of the bores preferably steadily decrease (preferably spherical comb profile, comb tips smoothed), wherein a retaining ring can be dispensed with, and wherein the axle fixing can advantageously be extended in length. The axle dowel 15 herein can also be thickened at one side so as to compensate for positional tolerances of the carrier bores by way of orientation during assembling. Alternatively or additionally to the conical embodiment, the coefficient of friction can also be increased by laser structuring or else selectively by chemical structuring and/or cold welding for microstructure and/or nanostructure adhesion, selectively also in combination with a knurling or shaping according to a knurling (for example by milling, embossing, pressing). In terms of a potential relative movement axially toward the outside, the proportional static friction force herein can advantageously be increased, wherein an advantageously high compressive strength of the carrier material can also be exploited. The dowel 15 can selectively also be slotted or segmented so as to facilitate deformation. The material of the axle grommet is preferably hardened or nitrated, selectively with or without a coating that facilitates assembling. The bores can be fitted, for example, by induction or by cold joining. The axle ends herein can be embodied so as to be, for example, straight cylindrical, conical or helically profiled. Sidenote: FIG. 6B herein only visualizes part of the inter-axle grommet 15, which is designed in an encircling annular manner, in the sectional view.

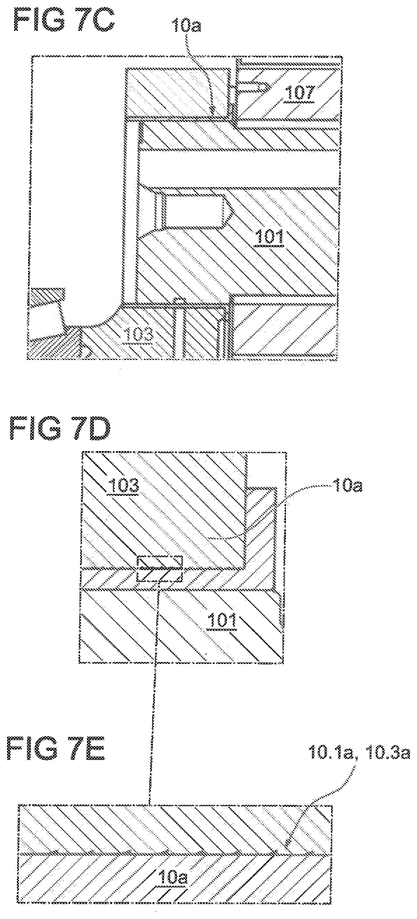

A design embodiment of at least one intermediate element 10a of the intermediate element assembly 10 as a sleeve 11 having an integrated run-up contour 12 is visualized in different views of the installation situation in FIGS. 7A to 7E: The axle receptacle 103 is shown in FIG. 7A. The at least one intermediate element 10a is shown in an intended disposal between the axle and the axle receptacle in a greatly enlarged view in FIG. 7B. The axle and the axle receptacle are visible across the entire thickness of the axle in FIG. 7C. A/the outer surface structure 10.1a having a surface portion 10.3a, specified for a form fit, of the at least one intermediate element of the intermediate element assembly is shown in detail in FIG. 7D and FIG. 7E.

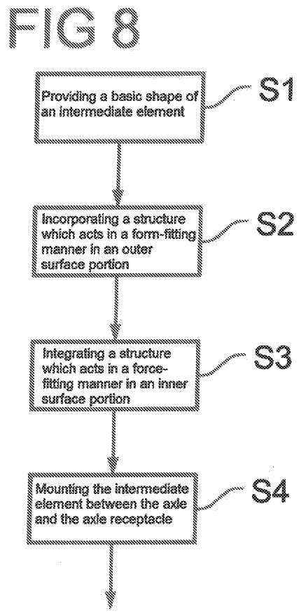

Individual steps of a production method of an intermediate element assembly 10 described here are schematically indicated in FIG. 8, specifically: Step S1 providing a basic shape, or a basic body of a separate intermediate element; Step S2 incorporating a structure which acts in a form-fitting manner; Step S3 incorporating a structure which acts in a force-fitting manner; Step S4 assembling the respective intermediate element. The production method can selectively comprise steps S1 to S3, or all steps S1 to S4, depending on whether the production relates only to the individual intermediate elements 10a or to the entire intermediate element assembly 10, or the corresponding industrial gear unit 100.

### LIST OF REFERENCE SIGNS

10 Intermediate element assembly
10a Intermediate element
10.1 Structured surface
10.1a, 10.1b Radially outer or inner surface (portion)
10.3a Form-fitting portion
10.3b Force-fitting portion
11 Sleeve, in particular slotted sleeve
11.1 Slot
12 Run-up contour or run-up face (portion)
12.1 Friction bearing-coated surface/end side
12.3 Radial slots or similar cutouts
13 Formed bushing, for example L-shaped
13.1 Friction bearing-coated surface/end side
14.1 Internal nut
14.3 Cone (conical axle seat)
15 Inter-axle grommet, in particular conically shaped
20 Axially fixed form-fitting/force-fitting connection between axle and axle receptacle
100 Industrial gear unit
101 Axle, in particular planetary axle
103 Axle receptacle, e.g. bore in casting, in particular planet carrier bore
105 Planet carrier
107 Planet, or planet gear
109 Planet ring gear with internal toothing
S1 Providing a basic shape, or a basic body of a separate intermediate element
S2 Incorporating a structure acting in a form-fitting manner
S3 Incorporating a structure acting in a force-fitting manner
S4 Assembling the respective intermediate element
X1, X2 First and second axial portion in axial receptacle
x, r Axial direction, radial direction

1.-26. (canceled)

27. An industrial gear unit designed as a planetary transmission for installation in a wind power installation, the industrial gear unit comprising:
an axle receptacle;
an axle including two axial portions via which the axle is mounted in the axle receptacle in an axially fixed manner on both sides of a planet gear of the planetary transmission; and
an intermediate element assembly mounted in an axially fixed manner between the axle and the axle receptacle in at least one of the two axial portions of the axle and acting between the axle receptacle and the axle, said intermediate element assembly including a surface portion which faces the axle and/or the axle receptacle and comprises a structured surface with a laser-structured surface for restraining the intermediate element assembly against displacement in an axial direction.

28. The industrial gear unit of claim 27, wherein the intermediate element assembly comprises an intermediate element having a configuration selected from the group consisting of slotted sleeve, formed bushing, formed bushing with internal nut, formed bushing in combination with cone, and inter-axle grommet.

29. The industrial gear unit of claim 27, wherein the intermediate element assembly comprises an intermediate element, said structured surface being formed on an outer shell face of the intermediate element and having a geometric configuration selected from the group consisting of conical, spherical, knurled, provided with a toothing, and shaped so as to be helical or wave-shaped.

30. The industrial gear unit of claim 27, wherein the intermediate element assembly comprises an intermediate element designed for placement between the axle and the axle receptacle in a manner of a dowel.

31. The industrial gear unit of claim 27, wherein the laser-structured surface is incorporated in a specific circumferential position.

32. The industrial gear unit of claim 27, wherein the planetary transmission includes a planet carrier, said intermediate element assembly comprising a multiplicity of intermediate elements which, conjointly with respective axles form support rods of the planet carrier.

33. The industrial gear unit of claim 27, wherein the intermediate element assembly comprises an intermediate element which is mounted in an axially fixed manner between the axle and the axle receptacle in the at least one of the two axial portions and which includes in facing relation to the axle receptacle an outer surface portion which has a structured surface that acts in a form fitting manner and which has a hardness which is greater than a hardness of a corresponding surface of the axle receptacle, said intermediate element including in facing relation to the axle an inner surface portion which has a structured surface that acts in a force-fitting manner.

34. The industrial gear unit of claim 27, wherein the intermediate element assembly comprises an intermediate element which includes a layer of a material with a hardness dissimilar to a hardness of a material of the axle and/or of the axle receptacle.

35. The industrial gear unit of claim 27, wherein the intermediate element assembly comprises an intermediate element which is designed as a slotted sleeve, wherein the structured surface for a form-fitting support in the axial direction in the at least one of the two axial portions is provided on an outside with a surface structure which acts in a form-fitting manner.

36. The industrial gear unit of claim 27, wherein the intermediate element assembly comprises an intermediate element which is designed as a formed bushing, wherein the structured surface for a form-fitting support in the axial direction in the at least one of the two axial portions is provided on an outside with a surface structure which acts in a form-fitting manner, wherein the formed bushing is secured in the axial direction on the axle by an internal nut or by a cone.

37. The industrial gear unit of claim 27, wherein the intermediate element assembly comprises an intermediate element with an outer structure of a roughness which is greater than a roughness of the laser-structured surface in facing relation to the axle.

38. The industrial gear unit of claim 27, wherein the intermediate element assembly comprises an intermediate element which is formed from a plurality of layers of different hardness dissimilar to a hardness of a material of the axle or of the axle receptacle.

39. The industrial gear unit of claim 27, wherein the structured surface of the surface portion of the intermediate element assembly is individualized by line density, direction of structure, intensity and shape of structure.

40. The industrial gear unit of claim 27, wherein the planetary transmission comprises a planet carrier, said axle receptacle being formed in the planet carrier in the form of a planet carrier bore, said intermediate element assembly comprising an intermediate element disposed on the axle receptacle on a shell face at least substantially in a force-fitting manner so as to restrain an axial movement between the planet carrier, or the axle receptacle, and the axle, or to act there in a wear-reducing or wear-preventing manner.

41. The industrial gear unit of claim 27, designed for installation in a power train of the wind power installation, wherein the planetary transmission comprises a planetary transmission stage.

42. The industrial gear unit of claim 27, wherein the intermediate element assembly includes a first intermediate element mounted in an axially fixed manner in a first one of the two axial portions, and a second intermediate element mounted in an axially fixed manner in a second one of the two axial portions, with the first and second intermediate elements having each an inner surface which bears on the axle in a substantially force-fitting manner, and an outer surface which bears on the axle in a substantially form-fitting manner, wherein the first and second intermediate elements are designed of a same type or of different types, and of a configuration selected from the group consisting of sleeve, and formed bushing selectively in combination with an internal nut and/or cone.

43. A method, comprising:
forming in a surface portion of an intermediate element of an intermediate element assembly intended for installation in an industrial gear unit designed as a planetary transmission, a structured surface comprising a laser-structured surface in facing relation to an axle and/or an axle receptacle of the industrial gear unit for effecting a force-fitting and selectively also a form-fitting support so as to restrain the intermediate element assembly against displacement in an axial direction; and
mounting the intermediate element assembly in an axially fixed manner in two axial portions of the axle between the axle and the axle receptacle in the axle receptacle on both sides of a planet gear of the planetary transmission.

44. The method of claim 43, wherein when the surface portion is on an inner surface or shell face of the intermediate element, the method further comprising generating the structured surface with a surface for acting in a substantially force-fitting manner as a function of a predefined relief parameter and/or density parameter, in particular in a wave-shaped or serpentine structure, or in an imbricated structure, by a process selected from the group consisting of laser structuring and chemical structuring, or when the surface portion is on an outer surface or shell face of the intermediate element, the method further comprising generating the structured surface with a surface for acting in a substantially form-fitting manner by a process selected from the group consisting of sawtooth profiling and fine thread tapping, or when mounting the intermediate element of the intermediate element assembly between the axle and the axle receptacle, a pairing of the axle and the axle receptacle is expanded by the intermediate element.

45. An intermediate element assembly for installation between an axle receptacle and an axle of an industrial gear unit, the intermediate element assembly comprising an intermediate element designed to provide a wear-reducing or wear-preventing effect between the axle and the axle receptacle and comprising a surface portion having a structured surface with a laser-structured surface for effecting a force-fitting support and selectively also a form-fitting support so that the intermediate element assembly is restrained against displacement in an axial direction, with the structured surface being produced by laser structuring and selectively also by chemical structuring or cold welding, and with the form-fitting support of the structured surface produced by sawtooth profiling or fine thread tapping.

46. The intermediate element assembly of claim 45, wherein the intermediate element includes an outer shell face having a form-fitting contour in an outer shell face portion for realizing the form-fitting support in the axle receptacle, and an inner shell face, said laser-structured structure being provided on the inner shell face for realizing the force-fitting support on the axle, wherein the intermediate element is designed the form of a sleeve or a formed bushing.
